(19) United States
(12) Patent Application Publication
(10) Pub. No.: US 2026/0106741 A1
(43) Pub. Date: Apr. 16, 2026

(54) Encryption method using geometric encryption and geometric random number generation

(71) Applicant: Leith Tidwell, Provo, UT (US)

(72) Inventor: Leith Tidwell, Provo, UT (US)

(73) Assignee: Leith Tidwell, Provo, UT (US)

(21) Appl. No.: 18/914,001

(22) Filed: Oct. 11, 2024

Related U.S. Application Data
(60) Provisional application No. 63/672,023, filed on Jul. 16, 2024.

(51) Int. Cl. H04L 9/08

(52) U.S. Cl. CPC H04L 9/0869

(57) ABSTRACT

The present invention is an encryption method utilizing a novel random number generator and geometric fields to create encryption keys. The novel random number generator uses geometric graph sampling and cellular automaton distributions to generate random number sets suitable for encryption use. The encryption method portion uses graph analysis to create elliptic curves suitable for encryption key generation.

### FIELD OF THE INVENTION

The present method invention relates to cryptography and encryption of data.

### BACKGROUND OF THE INVENTION

Cryptography is developed from the idea the key you use to encrypt data can be shared publicly and executed privately. This encryption requires a series of equations easy to execute but difficult to reverse. The difference between ease in executing a method in one direction and difficulty in reversal of the method is considered the overall strength of a cryptographic system. Most current cryptographic systems utilize either multiplication of random numbers with the strength of encryption depending on the difficulty of factoring or breakdown of the multiplication or the generation of an encryption key using graphical curve equations for random variables. Modern electronic systems have reduced ability to process large numbers which limits the potential length of encryption keys available to cryptographic systems.

### DESCRIPTION OF THE INVENTION

The present invention is a method which increases the strength of encryption while reducing the time complexity needed for computation. This cryptographic system uses the following steps:
1) generate geometric graph.
2) sample random numbers from geometric graph.
3) generate geometric graph with random numbers sampled in Step 2.
4) sample geometric graph.
5) generate a cellular automaton distribution using the random number set generated by the geometric graph.
6) use random number from geometric graph sampling for cellular automaton seed to form random number sequence within assigned range.
7) generate geometric graphs with the obtained random number set.
8) identify nodes on each graph.
9) create fields using identified nodes on geometric graphs.
10) create elliptic curves for encryption using geometric graphs from Step 7 and fields from Step 9.

### Example Embodiments

The present invention can use random number generation, mathematical equations, graphs, and curves to establish an encryption key. These include, but are not limited to, geometric equations, graph theory, and elliptic curves.

### Objects and Advantages

A new method of encryption is created which allows users to strengthen data protection through graph randomization while maintaining limited time complexity for computation. This method gives users stronger encryption without requiring increased computational ability or time requirements.

1. The present invention is a method for strengthening cryptographic systems using randomly generated numbers, graphs, and curves in encryption key generation. This method increases cryptographic complexity.
